(19) United States
(12) Patent Application Publication
(10) Pub. No.: US 2003/0113063 A1
(43) Pub. Date: Jun. 19, 2003

(54) Method and apparatus for enhancing power saturation in semiconductor optical amplifiers

(76) Inventor: Yet-Zen Liu, Westlake Village, CA (US)

Correspondence Address: Tejinder Singh, Newport Law Group, 5001 Birch Street, Newport Beach, CA, 92660, US

(21) Appl. No.: 10/024,856

(22) Filed: Dec. 18, 2001

(51) Int. Cl. G02B 6/26

(52) U.S. Cl. 385/28; 385/39; 385/43; 359/333

(57) ABSTRACT

A method and apparatus for improving gain volume in semiconductor optical amplifiers is provided. A multi-mode interference coupler is used for expanding incoming optical signal. Thereafter, another multi-mode interference coupler combines the expanded optical signal.

### BACKGROUND OF THE INVENTION

1. Field of the Invention

The present invention relates to devices and methods used in fiber optics networks and more particularly, to semiconductor optical amplifiers.

2. Background

Semiconductor optical amplifiers (hereinafter referred as “optical amplifier” or “optical amplifiers”) are frequently used in fiber optics networks. FIG. 1A shows a top level block diagram of a fiber optics network 100, which includes transmitter 101 that receives an electrical input (not shown) and converts it to an optical output 102 using a laser diode (not shown). Optical signal 102 is transmitted via optical fiber (not shown) to optical amplifier 103. Optical amplifier 103, described below in FIG. 1B, amplifies optical signal 102 and the amplified signal 102′ is transmitted to photodetector 105, via filter 104.

FIG. 1B shows a top-level block diagram of a conventional optical amplifier 103. Absorption layer (or active layer) 103B is located between two semiconductor layers 103A and 103C. Optical signal 102 enters absorption layer 103B and electric current 103D is applied to amplifier 103. Electrons due to current 103D are stimulated to an excited state but move to a ground state due to optical signal 102. Photons are generated when electrons lose energy by moving from the excited state to the ground state. The generated photons combine with the photons in optical signal 102 that caused the emission in the first place, and optical signal 102 is amplified to signal 102′.

Typically, optical amplifier 103 is compatible with only single mode fibers. FIG. 1C shows the top view of optical amplifier 103 with a single mode waveguide 103E that receives incoming optical signal 102 (FIG. 1A) through optical fiber 106A. Waveguides are used by optical amplifiers to guide electromagnetic or optical light in a direction parallel to the waveguide axis. Optical signal 102 (FIG. 1C) travels through waveguide 103E and emits an amplified signal 102′ to optical fiber 106B.

Typically, optical amplifier 103 must have high power saturation for efficiently amplifying optical signal 102. Conventional optical amplifiers have drawbacks due to gain saturation because the gain in optical amplifier 103 is limited by available electrons injected in gain medium (absorption layer 103B, FIG. 1B).

One solution to the foregoing gain saturation problem is to forego the single mode property and expand the gain medium width. This is illustrated in FIG. 1D. Optical signal 102 enters single mode waveguide 103E through fiber 106A, passes through expanded gain region 107, and exits through cylindrical lens 108 and lens 109 into optical fiber 106B. FIG. 1E shows the side view of the FIG. 1D optical system. The optics shown in FIGS. 1D and 1E for improving gain volume are very complicated and increase the overall cost of amplifying optical signal 102.

Therefore, there is a need to improve power saturation in a photodetector without complex optics or increasing the overall cost of amplification.

### SUMMARY OF THE INVENTION

In one aspect of the present invention, the foregoing deficiencies are addressed by providing an apparatus for increasing gain volume in an optical amplifier without complicated and expensive optics. The apparatus includes an expansion region that receives and expands incoming optical signal. The expansion region is coupled to plural waveguides through which expanded incoming optical lights are reduced in intensity by a factor of N, with N being the number of single mode amplifer channels. So, the expanded optical signal can be amplified to its limit and then travel to a “combination” region. The combination region combines the expanded optical signal into a single beam. Both the expansion and combination regions operate as multi-mode interference (“MMI”) couplers.

In another aspect of the present invention, the MMI couplers are less complicated and cheaper than the complex optics described above and shown in FIGS. 1D and 1E.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1A as described above is a top-level block diagram of a conventional fiber optics network.

FIG. 1B as described above is a block diagram of a conventional optical amplifier.

FIG. 1C as described above is a top view of a conventional optical amplifier with a single mode waveguide.

FIG. 1D as described above is a top view of a conventional optical amplifier with a flared gain region.

FIG. 1E as described above is a side view of a conventional optical amplifier of FIG. 1D.

FIG. 2A is a top view of an optical amplifier according to an embodiment of the present invention.

FIG. 2B is a flow diagram according to an embodiment of the present invention.

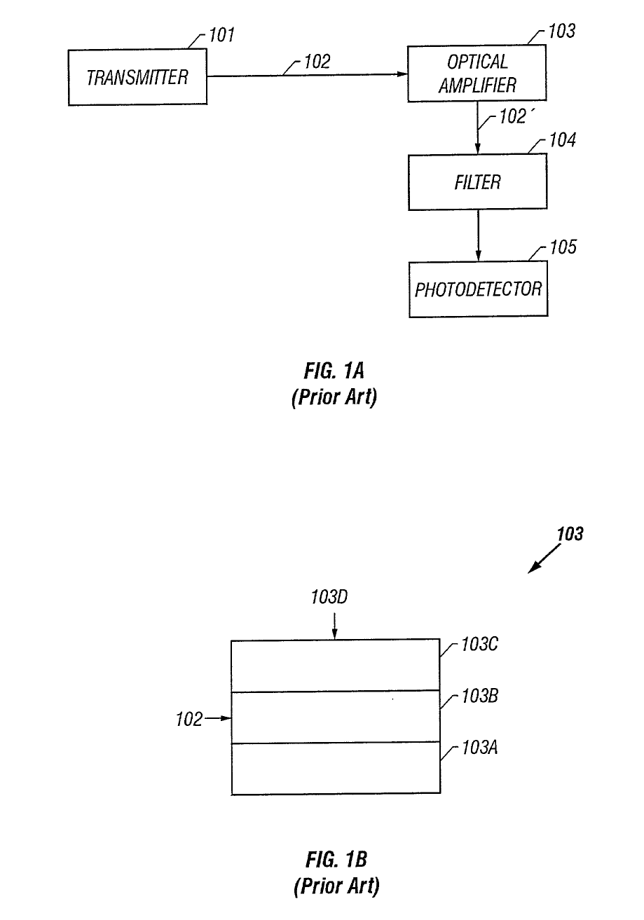

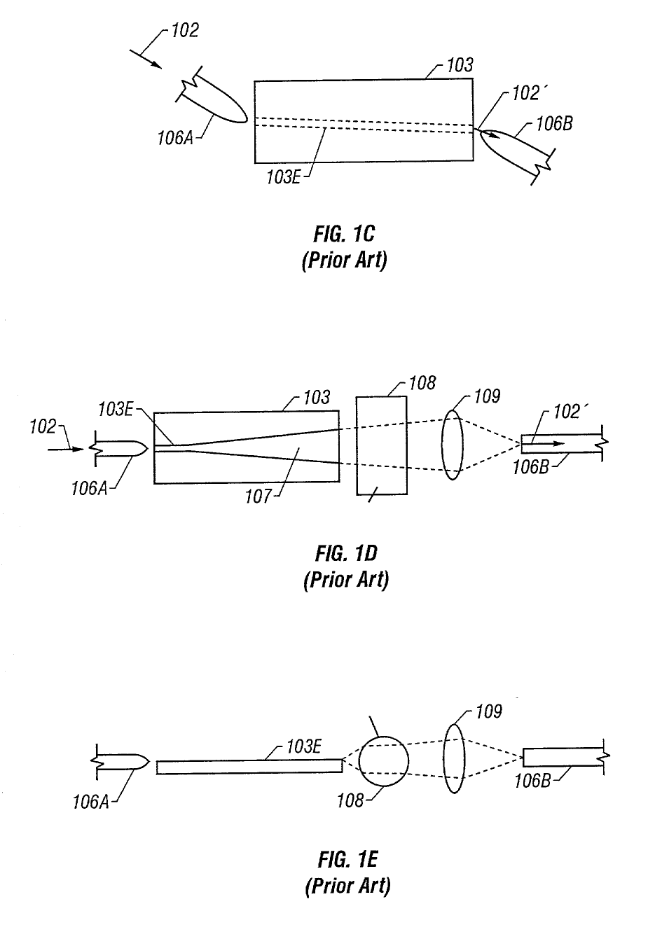

Features appearing in multiple figures with the same reference numeral are the same unless otherwise indicated.

### DETAILED DESCRIPTION

In one aspect of the present invention, a system is provided that expands incoming optical signal using multi mode interference couplers; thereafter the expanded or split, optical signal travels through a waveguide and is combined by a combining device that also operates as a multi mode interference coupler. The expansion and combining of incoming optical signal is performed without complex and expensive optical systems.

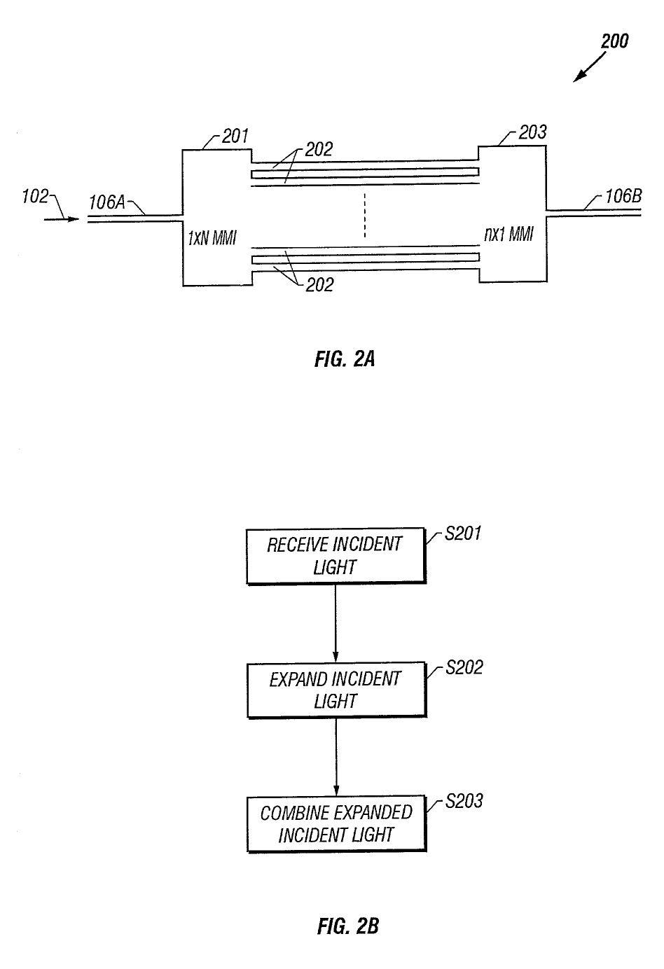

Referring in detail to FIG. 2A, is an optical amplifier 200 according to an embodiment of the present invention that utilizes multi-mode interference (“MMI”) couplers to expand and combine optical signals. Optical fiber 106A is coupled with a MMI Expander 201, which in turn is coupled to plural single mode waveguides 202. Waveguides 202 are coupled to a MMI combiner 203 that receives amplified optical signal from waveguides 202 and combines them into a single beam (not shown) that is transmitted through optical fiber 106B.

Input optical beam 102 enters Expander 201 and expands. Expander 201 operates as a MMI coupler between optical fiber 106A and waveguides 202. The expanded optical beam (not shown) propagates through Expander 201 and forms in-phase, as well as out of phase interference pattern. The condition for in-phase resonance is given as follows:

[L=Neff W²/Nλ]

where Neff is the effective refractive index of the MMI region, L is the length of Expander 201, N is the number of output waveguides, W is the width of MMI Expander 201 and λ is the wavelength of the input optical beam. When the MMI is designed with a length L and a width W that satisfies equation (1), the split light entering waveguides 202 are in phase. Equation (1) also applies to MMI in the opposite direction so the same design can work as a combiner when the multiple inputs are in phase. In addition, the insertion loss, i.e., the cumulative optical power in waveguides 202 as a fraction of incoming power in waveguide 106A, is near 100 percent. This means that the penalty the use the MMI for both splitting and combining optical power is relatively low.

In another aspect of the present invention, a process is provided such that incoming optical signal is expanded using a MMI based expansion region; the expanded optical signal then travels through plural single mode waveguides; and thereafter, combined by a MMI based combiner.

Referring to FIG. 2B, a flow diagram is provided for improving gain in an optical amplifier without using complex optics, comprising the steps of: receiving incident light; expanding the incident light using an MMI expander; and then combining the expanded optical signal using a MMI combiner.

Turning in detail to FIG. 2B, in step S201, incoming optical signal is received by the optical fiber. FIG. 2A shows incoming optical beam 102 received by optical fiber 106A.

In step S202, input light is expanded. As shown in FIG. 2A, optical beam 102 enters MMI expander 201 and is expanded based upon multimode interference principles. Input optical beam 102 diffracts and expands as it enters Expander 201, and forms in-phase and out of phase interference patterns as it propagates through Expander 201 and through plural waveguides 202. The condition for in-phase resonance is given by:

L=Neff W²/Nλ

where Neff is the effective refractive index of the MMI.

In step S203, the expanded optical beam is combined. According to FIG. 2B, a MMI combiner 203 combines the expanded light (not shown) using multi-mode interference coupling principles. The combined light leaves optical amplifier 200 via optical fiber 106B.

Another aspect of the present invention is that power saturation is improved and MMI couplers are less complicated and cheaper than conventional optics described above.

While the present invention is described above with respect to what is currently consider its preferred embodiments, it is to be understood that the invention is not limited to that described above. To the contrary, the invention is intended to cover various modifications and equivalent arrangements within the spirit and scope of the appended claims.

What is claimed is:

1. A semiconductor optical amplifier, comprising:
a multi-mode interference (“MMI”) expander for expanding an incoming optical signal.

2. The optical amplifier of claim 1, further comprising:
a MMI combiner for combining the expanded optical signal into a single mode output.

3. The optical amplifier of claim 1, wherein the incoming optical signal forms in-phase interference pattern in the expander.

4. The optical amplifier of claim 1, further comprising:
a plurality of waveguides through which the expanded incoming optical signal travels to the MMI combiner.

5. An apparatus for improving gain volume in semiconductor optical amplifiers, comprising:
means for expanding an incoming optical signal.

6. The apparatus of claim 5, further comprising:
means for combining the expanded optical signal.

7. The apparatus of claim 5, wherein the means for expanding the optical signal is based on multi-mode interference couplers.

8. The apparatus of claim 6, wherein the means for combining the expanded optical beam is based on multimode interference couplers.

9. A method for increasing gain volume in semiconductor optical amplifiers, comprising:
expanding an incoming optical signal, wherein the incoming optical signal is expanded by multi-mode interference expander.

10. The method of claim 9, further comprising:
combining the expanded optical signal, wherein the expanded optical signal is combined by multimode interference based combiner.

11. The method of claim 10, wherein the expanded optical signal travels to the multimode interference combiner through plural waveguides.

12. A system for a semiconductor optical amplifier, comprising:
a multi-mode interference (“MMI”) expander for expanding an incoming optical signal.

13. The system of claim 12, further comprising:
a MMI combiner for combining the expanded incoming optical signal into a single mode output.

14. The system of claim 12, wherein the incoming optical signal forms in-phase interference pattern in the expander.

15. The system of claim 12, further comprising:
a plurality of waveguides through which the expanded incoming optical signal travels to the MMI combiner.
